(19) United States
(12) Patent Application Publication
(10) Pub. No.: US 2009/0016650 A1
(43) Pub. Date: Jan. 15, 2009

(54) HANDHELD IMAGE PROCESSING APPARATUS

(76) Inventors: Alan Joseph Bell, Hampshire (GB); Martin James Robinson, Hampshire (GB); John David Wellbelove, Hampshire (GB); Antonio Cavallo, Hampshire (GB); Simon White, Hampshire (GB); Sascha Christoph Hrastnik, Hampshire (GB)

Correspondence Address: KOPPEL, PATRICK & HEYBL, 555 ST. CHARLES DRIVE, SUITE 107, THOUSAND OAKS, CA, 91360, US

(21) Appl. No.: 12/064,069

(22) PCT Filed: Aug. 17, 2006
(86) PCT No.: PCT/GB2006/003086

§ 371 Date: Sep. 24, 2008

(30) Foreign Application Priority Data
Aug. 17, 2005 (GB) 0516848.9

(51) Int. Cl. G06K 9/22; H04N 5/76; H04N 5/222; H04N 5/225

(52) U.S. Cl. 382/313; 348/231.99; 348/335; 348/370; 348/E05.024; 348/E05.022

(57) ABSTRACT

A handheld inspection apparatus for inspecting an object in a non-contact manner is provided, the apparatus comprising: a telecentric lens arrangement comprising a telecentric lens arranged to collect light rays projected or reflected from an object to be inspected; a mobile image sensing device such as a CCD digital camera arranged with respect to the telecentric lens to receive the lights rays collected by the telecentric lens and convert these into an image representative of the object, wherein the telecentric lens is arranged such that movement of the apparatus in a direction away from or towards the object causes the image to remain of the same size on the image sensing device. Preferably an illumination unit is provided which is detachably mounted on the camera and is interchangeable depending on the purpose.

The present invention relates to image processing and particularly to a handheld image processing apparatus which is capable of creating dimensionally precise images of an object.

Image capturing is a well-known concept and many devices exist to capture images. For example digital cameras are used to capture images of objects and the size of the image will vary depending on the distance of the lens of the camera with respect to the object.

Laboratory and robotic production line image capture equipment exists where the distance from the camera to object being analysed is strictly controlled.

The present invention provides a portable image processing apparatus which is handheld and allows a user to create dimensionally precise images, with typical resolution and precision of 25 to 50 μm without the need for precise control of camera to object distance that is normally undertaken mechanically.

In particular the apparatus includes a capturing device such as a handheld camera, and a telecentric lens arrangement, the latter being arranged such that an object is viewed through the lens and the object does not change size over the working range of the lens. The handheld camera is configured to capture the image viewed through the lens.

The advantage of using a telecentric lens is that the apparatus can be maintained at an acceptable distance from the object being imaged and dimensionally useful data can be extracted from the images without relying on precise control of the distance between the lens and the object, that would otherwise affect the size of the image and thus the values of the dimensions being measured.

Preferably a detachable illumination unit is provided on the lens to enable optical assemblies which enhance the object being viewed to be included. Such assemblies may include light sources and filters.

In order that the present invention be more readily understood embodiments thereof will be described with reference to the accompanying drawings in which:

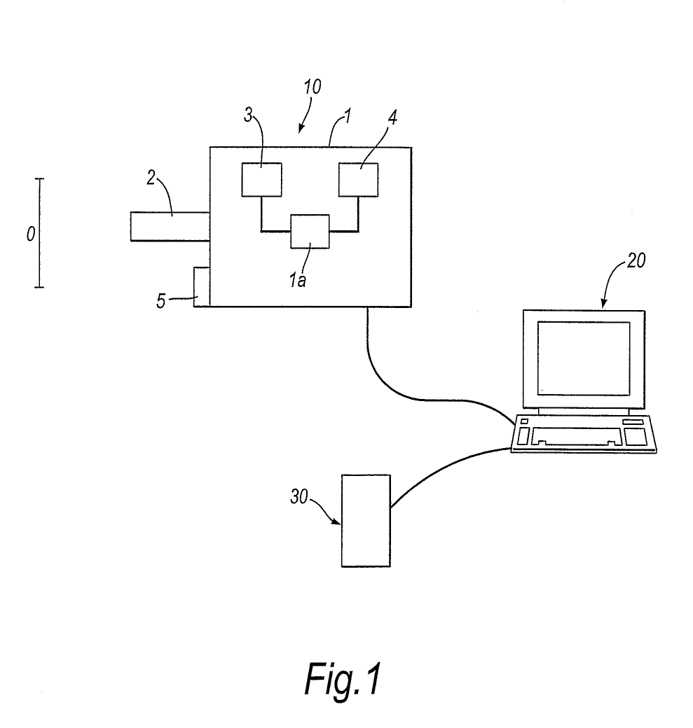

FIG. 1 shows a diagrammatic representation of a first embodiment of the present invention;

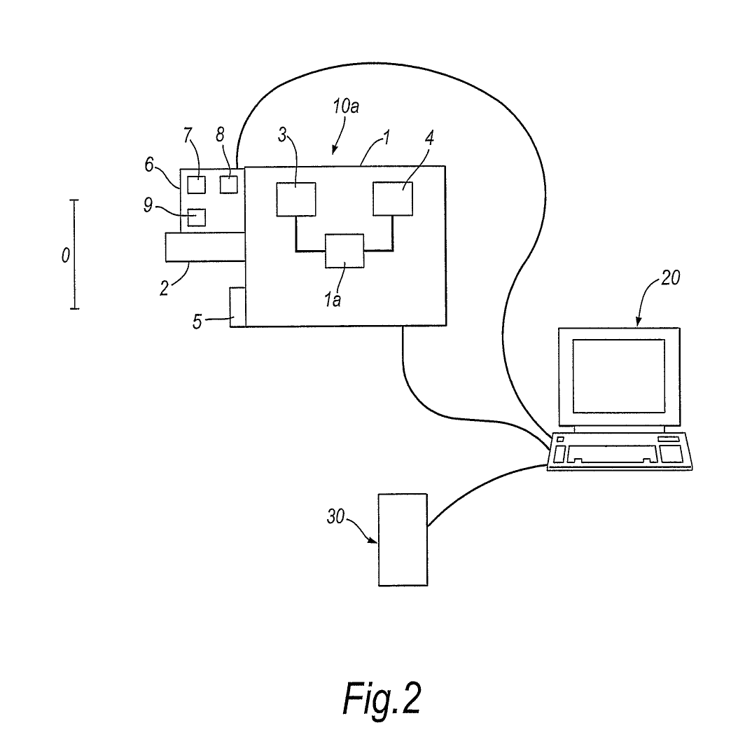

FIG. 2 shows a diagrammatic representation of a modified version of the first embodiment;

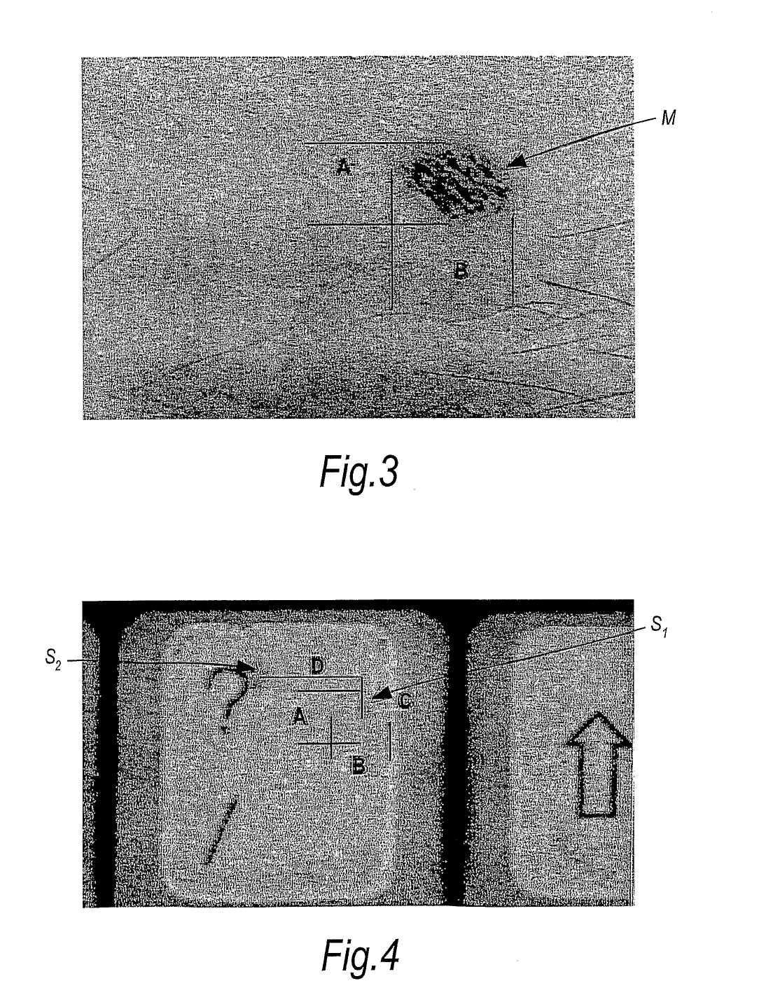

FIG. 3 shows a first type of object which can be inspected by the apparatus of FIG. 1 or 2;

FIG. 4 shows a second type of object which can be inspected by the apparatus of the FIG. 1 or 2;

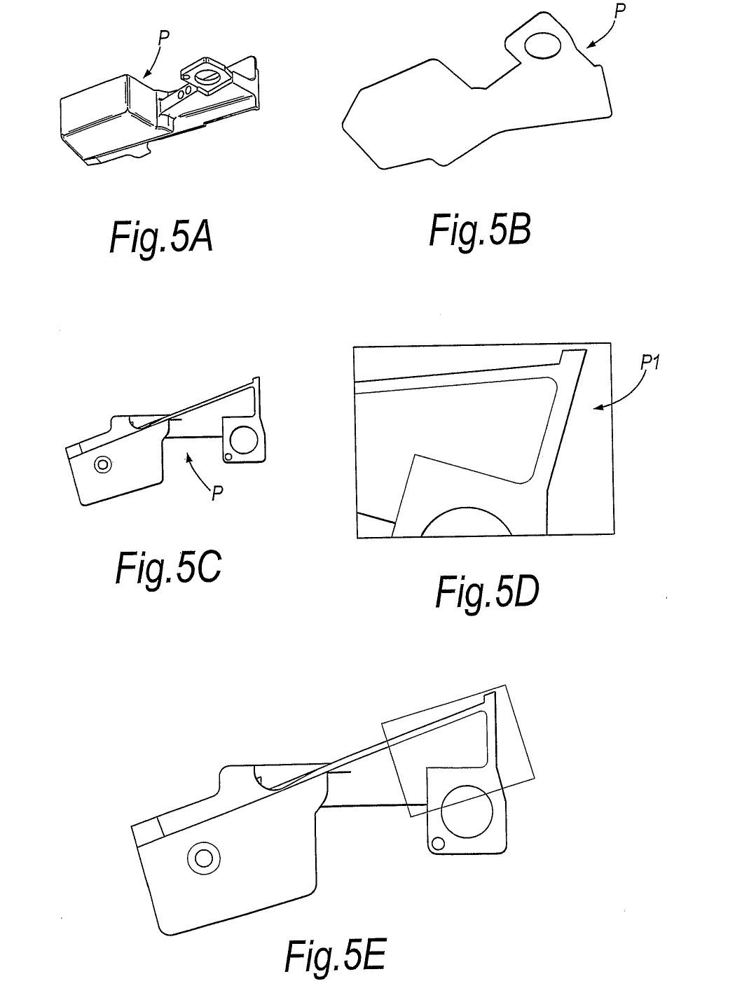

FIG. 5A-E shows different representations of a third type of object which can be inspected by the apparatus of FIG. 1 or 2.

The present invention provides an image processing apparatus which is handheld and capable of capturing images of an object and determining accurate dimensional data with respect to the object without relying on the distance between the apparatus and the object.

A first embodiment of the present invention comprises a handheld digital camera 1 which is capable of capturing images. The camera includes a well-known charge coupled device (CCD) and is known in the art for sensing images using capacitors which are sensitive to light. It will be appreciated that the invention is not limited to charge coupled devices and may use any other method which is capable of sensing an image. For example CMOS sensors could be used although these are less sensitive than CCD and can be subject to image distortion when the object being imaged is moving relative to the camera.

Attached to the digital camera is a telecentric lens 2 which has properties known in the art. That is, the lens is capable of exhibiting constant magnification whereby an image of object O remains the same size over the working distance of the lens. It is known to those in the art that the focus of the object O does not necessarily remain the same when the distance is varied when using this type of lens. The lens 2 is adapted to be capable of viewing the object O in a non-contact manner such that a gap exists between the object O and the lens 2 or camera unit 10 itself.

The camera 1 and telecentric lens 2 combine to form a camera unit 10 which is used for capturing images of the object O.

The camera unit 10 comprises means for connecting to a computer 20 which contains an application program to be used with the camera unit 10. The connection can be a cable connection such as USB or “firewire” or similar connection. Alternatively or in addition there may be a wireless connection between the camera unit 10 and computer 20 adding to the mobile characteristics of the camera unit 10.

This application program is capable of analysing data from the camera unit 10 and using this data to determine accurate measurements regarding colour, size, density, shape or any other characteristic of the object O being imaged. This analysis may occur in real time whilst imaging is taking place by the camera unit 10 or stored locally in the camera unit 10 and downloaded to the computer 20 for analysis. If the data is to be stored locally, a memory unit 3 is provided to store the data. This may be any type of memory such as flash memory and may be removable from the camera unit 10.

The image of the object O may be captured by the camera unit 10 over a period of time and any changes in the captured image can be deduced using the application program by comparing the captured images.

The camera unit may include the equivalent of a manually operable shutter release to capture a single frame or a sequence of frames.

The camera unit 10 is formed such that it is handheld and mobile thus being easily movable by a user. One known property of telecentric lenses is that it is preferable to choose a lens size which has a diameter exceeding the size of the object O being viewed. Therefore, conventionally telecentric lenses are considerably large in order to obtain an image of an overall object.

In this embodiment the object O is indeed larger than the diameter of the lens 2 but this is handled by the camera unit 10 through the ability of capturing a series of images that when combined by overlapping sections of an adjacent image produces a larger image. In this connection, a complete image of the object can be formed regardless of the relative size of the object with respect to the telecentric lens 2. This is known as image stitching and can be carried out in real time or after a complete set of images have been captured. A controller 1a is optionally provided in the camera 1 in order to process images locally and perform the image stitching function.

For the image stitching to be performed in real time by the camera unit 10, a screen 4 is provided to enable the user to display the captured image which is stored in the memory 3. The camera unit 10 is arranged to capture a series of images in quick succession by moving the camera unit 10 over the object O to be inspected. The real time analysis combines the images obtained and displays the combined larger image on the screen so that the additional images added to the previous image are discernible. Any areas that have been missed can also be deduced.

The real time analysis can also be used in conjunction with an image recognition system (not shown) built into the camera and/or in the computer which can review images whilst they are being assimilated by comparing features of the current image with predetermined features of known images. This can classify the image in real time.

Moreover, the computer 20 may already contain a software model of the object O which is being inspected and this model can be transferred to the camera unit 10 and displayed on the screen 4. This provides an image of the object which should be seen at a given position on the basis of the software model. It will be appreciated that the software model may be an actual image of the object which has been taken previously. The application program on the computer can compare the real time image captured by the camera unit 10 and the predetermined software model to obtain comparison data between the theoretical and actual data. This comparison data can be reviewed by a user and any deviations between the theoretical and actual data can be accepted or rejected thereby providing a record in the captured image of the difference between the software model and the item being imaged.

The stitching of two images together to form a larger image may rely on matching distinct features of the common parts of overlapping single frames. This is used conventionally but certain objects being captured may have inconsistent or indistinct features which makes the conventional image stitching method more difficult.

In view of this, the camera includes position sensors 5 for indicating the relative distance traveled, and the offset between subsequently captured images or adjacent frames. This will therefore reduce errors in stitching the overall image and enable tracking the movement of the camera unit 10.

It will be appreciated that different types of position sensors 5 may be utilised. For example, optical, mechanical, or wireless sensors may be used. The optical position sensors may use the lens of the camera unit 10 or a separate optical system adjacent the telecentric lens 2.

The computer 20 may in addition to or instead of the camera unit 10 obtain a series of images related to the object O and these images can be stitched together using the application program. This program will carry out a similar analysis in respect of image stitching as described above in relation to the camera unit 10. In particular, this may use the data from the position sensors 5 indicative of the distance traveled by the camera unit 10 between images to determine the offset of different images and obtain an overall image of the object O.

The camera unit may be mounted on a mechanically movable device such as a robot arm (not shown) to move the camera unit 10 over the object O. The robot arm comprises a tracking system which tracks the movement of the camera unit 10. This tracking system may be implemented separately to the robot arm if required.

Furthermore, the application program has the ability to use predictive data as an aid to the stitching by assuming that the camera unit 10 is not significantly accelerating between frames and thus the offset from a prior combination of images can be used as a start point for a subsequent combination. This reduces the processing needed to stitch adjacent images.

In order to collect the data gathered with respect to the object, a database 30 is provided which communicates with the application program of the computer 20. The database enables automated storage and retrieval of images and data relating to the images such as time the image was taken. It should be noted that the database does not need to be a separate unit to the computer 20 and can be implemented using computer software.

The operation of the camera unit 10 may be enhanced by adding indicators (not shown) that may be visual or acoustic that indicate that the camera unit 10 is the wrong distance from the object O for the image to be properly focussed. This enables the user (which may be a human or a robot arm responsive to such indicators) to adjust the distance until it is focussed. As mentioned hereinbefore the acuity of the image of the object varies with distance but the size of the image of the object does not as a result of the telecentric lens 2.

Furthermore, although not shown, information tags may be incorporated into the sequence of images that are used to generate the composite image by the camera unit 10. Tags may be bar codes or other visual indicators, voice recordings or button presses that are used by the user to indicate key points of interesting the composite image. Tags created by voice or button presses can be visible flags in the composite image or icons that when activated replay the voice recording taken at the time. Typically voice recording may be reference to the item being scanned, or feature of interest within the image of the object being scanned.

In a modification to the above embodiment, as shown in FIG. 2, an illumination unit 6 is detachably mounted on the front of the camera unit 10a. Otherwise the camera 10a is configured in the same manner as the camera 10 in FIG. 1. The unit 6 comprises a light source 7 arranged to direct light onto the object, and may include filter 8. The filter 8 is arranged in the illumination unit 6 such that when attached to the camera unit 10a, it is located between the lens 2 and the object O to be imaged. It will be appreciated however that the filter 8 may be located in a different position such as between the light source and the object.

The illumination unit 6 is interchangeable such that different types of unit 6 can be used with the camera unit 10 and 10a depending on the type of lighting required for a particular task. For this reason an electronic identification means 9 is provided in the illumination unit 6 to distinguish between other units 6. Furthermore this identification means (which may be in the form of an RFID tag) includes data representative of other characteristics of the illumination unit 6. This data can be obtained by the computer 20 which analyses data directly from the illumination unit 6 or can be read by the camera unit 10 and transferred to the computer 20. The identification means 9 may contain data representative of spectral characteristics of the light source 7 and optional filter 8 associated therewith as well as calibration data as may be used for correcting non-uniform illumination. This non-uniform illumination can be caused by the design or manufacturing variations between essentially similar illumination units 6.

The illumination unit 6 is configured to be synchronised with the camera frame rate. The frame rate is predetermined and can thus be preset on the application program of the computer 20 or the camera unit 10 itself. This data is used to set the illumination unit 6 to be activated in synchronisation with the frame rate.

The synchronisation allows the illumination to be on for a very short period of time. This reduces the blurring due to camera movement that would occur if the illumination were on continuously. The synchronous illumination also reduces the power consumption of the illumination because the lights may be switched off when not needed by the image sensor. The reduction in power use is advantageous for portable operation.

Different illumination units 6 may be optimised for different applications and be attached to the camera unit 10. The light source brightness can be controlled by the computer 20 when connected to the camera or by the camera itself. If there are a plurality of light sources 7, each can be separately controlled.

One type of illumination unit (not shown) has separate red, green and blue LEDs that have their brightness levels individually adjustable to give the ability to capture images with the light colour controlled by the application program on the computer 20.

Another type of illumination unit (not shown) has multiple lights that are precisely focussed originating from different directions. These may be energised in sequence in subsequent frames. The outcome would be images that can be used to measure surface irregularity by means of comparing shadows from images illuminated in each of the directions due to this irregularity or other brightness data.

Another type of illumination unit (not shown) has ultraviolet or other suitable excitation combined with filters to measure fluorescence or phosphorescence which occurs naturally or due to the presence of a biological or other chemical marker.

With regard to fluorescence, one such chemical marker is Magnaflux which is a liquid that has magnetic fluorescent particles in suspension. When applied to ferrous items under investigation the magnetic particles congregate around cracks. Looking at these aggregations under UV light shows where cracks and other surface deformities exist.

With regard to phosphorescence, light would have to be energised for a period of time. Subsequent images would show the phosphorescent decay time. A possible use of such a unit would be with security documents such as bank notes that commonly contain combinations of phosphorescent inks.

The apparatus according to the present invention has many uses, for example:

1) Clinical applications—wounds, moles, pre-cancerous growths and similar problems can be checked periodically and the rate of healing or development can be accurately monitored over time.

With reference to FIG. 3. an example is shown where the object to be inspected is a mole M. The mole M is 4.0 mm (A) by 5.9 mm (B). If the mole M changes size or colour, or develops a less defined edge it needs to be regarded as a possible melanoma (skin cancer). The darker pigmentation below and to the left of the mole M may also assist in clinical analysis.

The camera unit 10 combined with the illumination unit 6 produces a dimensionally robust image with controlled illumination that allows monitoring over different periods of time to be undertaken. The same technique could be used to monitor the efficacy of drugs in the treatment on skin conditions. In some applications it may be beneficial to use fluorescence or other types of illumination unit 6 which are suited to this specific use.

With this type of image there is no positional or angular reference available and thus the application program on the computer 20 may need to manipulate the image by rotation or translation such that the current image matches the orientation of historical images which are stored on the database 30.

2) Life sciences and Forensics—electrophoretic gels, the size of colonies in agar plates, and where the size of organic material regularly needs to be analysed and assessed can be accurately imaged.

FIG. 4 shows an image of some coffee splashes S₁ and S₂ on top of some key caps on a keyboard. The larger spot S₁ is 2.62 mm (A) by 2.97 mm (B) and the distance between the centre of the larger spot S₁ and the smaller spot S₂ is 5.71 mm (using dimensions C and D). It will be appreciated that instead of coffee splashes, the image could be cell colonies in an agar plate or biological evidence at a crime scene.

3) Inspection of Complex Parts—in manufacturing, profile data can be accurately created for complex shapes and simplify their measurement.

FIG. 5A shows a solid software model of a part P which is to be manufactured. This model is typically created using CAD software which is useful in allowing complex shapes that meet ergonomic and functional requirements to be created. The physical measurement of such parts can be difficult to perform using conventional gauges and micrometers. FIG. 5B shows a conventional digital image of overall the part P.

The part P shown in FIG. 5A is shown in a perspective view but a series of other views can be obtained by manipulating the solid model using the CAD software. For example FIG. 5C is a side view of the part P shown in FIG. 5A.

The camera unit 10 can be used to capture a series of images of the overall part P and one such image is shown in FIG. 5D which shows an end section P1 of the part P. In this connection, geometrically precise images are captured by the camera unit 10 and these can be matched against the corresponding view of solid model as shown in FIG. 5C. This can be carried out on the computer 20 or on the camera 10. FIG. 5E shows the matching that is a result of the comparison. The input data to the inspection process is the same as the input data to the manufacturing process and the application program on the computer 20 can merge these two sets of data greatly simplifying inspection. This technique can also be used to monitor manual or other imprecise assembly processes, such as fitting trim to a car body.

4) Aerospace monitoring of cracks or corrosion over time while maintaining an independent record of inspection data, whilst being able to transmit visual data to a remote expert for their consideration.

5) Museum archiving where highly detailed reproductions of work can be made by forming composite images of small areas with no risk to the item being digitised.

Accordingly it is apparent that the present invention has many uses where the inspection of an object is desirable but not convenient or possible with fixed cameras.

1. A handheld inspection apparatus for producing a dimensionally representative image of an object in a non-contact manner, the apparatus comprising:
a telecentric lens arrangement comprising a telecentric lens arranged to collect light rays projected or reflected from an object to be inspected;
a mobile image sensing device arranged with respect to the telecentric lens to receive the lights rays collected by the telecentric lens and convert these into a dimensionally representative image of the object, wherein the telecentric lens is arranged such that movement of the apparatus in a direction away from or towards the object causes the image to remain of the same size on the image sensing device, the apparatus further comprising:
means for storing a plurality of images, each image providing a representation of part of the object at different positions over the object surface; and
the image sensing device comprises a processor for analysing the plurality of images and generating a larger image on the basis of the images indicative of the overall object.

2. The apparatus of claim 1 further comprising at least one position sensor for indicating the position of the apparatus with respect to the object.

3. The apparatus according to claim 1 further comprising an indicator to indicate to a user when the image of the object to be inspected is out of focus.

4. The apparatus of claim 1, further comprising an illumination unit having a plurality of light sources, each light source adapted to be sequentially energised, in order to illuminate the object to be inspected with light rays.

5. The apparatus of claim 4 further comprising means for storing characteristics of the system for inputting the light rays into the image sensing device.

6. The apparatus of claim 4 wherein the illumination unit comprises at least one filter.

7. The apparatus of claim 4 wherein the illumination unit is detachably mounted on the side of the apparatus nearest to the object to be inspected.

8. The apparatus of claim 4 wherein the illumination unit comprises an electronic device for identifying the illumination apparatus.

9. The apparatus of claim 8 wherein the electronic device comprises data representative of the spectral characteristics and calibration data of the illumination apparatus.

10. The apparatus of claim 4 wherein the illumination is switched on and off synchronously with the image capture process in the image sensing device.

11. The apparatus of claim 1 wherein the image sensing device is a CCD digital camera.

12. A system for inspecting an object in a non-contact manner, the system comprising a handheld inspection apparatus according to claim 1 and a computing means arranged to receive actual image data representative of the one or more images captured by the handheld inspection apparatus and comparing the actual image data with predetermined image data.

13. The system of claim 12 further comprising a mechanical movable means wherein the handheld inspection apparatus is mounted on the movable means such the movement of the handheld inspection apparatus is based on movement of the movable means.

14. The system of claim 13 wherein the mechanically movable means is a robot arm.

15. A method of producing a dimensionally representative image of an object, the method comprising the steps of holding a camera unit including a telecentric lens with respect to the object such that a gap exists between the camera and capturing a series of images of the object by moving the camera unit over the object and combining the images in order to generate an overall image of the object.

16. A handheld inspection apparatus for producing a dimensionally representative image of an object in a non-contact manner, the apparatus comprising:
a telecentric lens arrangement comprising a telecentric lens arranged to collect light rays projected or reflected from an object to be inspected;
a mobile image sensing device arranged with respect to the telecentric lens to receive the light rays collected by the telecentric lens and convert these into an image representative of the object, wherein the telecentric lens is arranged such that movement of the apparatus in a direction away from or towards the object causes the image to remain of the same size on the image sensing device, the apparatus further comprising
an illumination unit for illuminating the object to be inspected, the illumination unit comprising a plurality of light sources for illuminating the object to be inspected with light rays, each light source adapted to be sequentially energised, and the image sensing device producing a plurality of images in response to the sequential energisation, the apparatus comprising means fro comparing the plurality of images in response to the sequential energisation, the apparatus comprising means for comparing the plurality of images in order to measure surface irregularity of the object.

17. The apparatus of claim 16 wherein the illumination unit comprises at least one filter.

18. The apparatus of claim 17 wherein the illumination unit is detachably mounted on the side of the apparatus nearest to the object to be inspected.

19. The apparatus of claim 16, further comprising means for storing characteristics of the system for inputting the light rays into the image sensing device.

20. The apparatus of claim 16 wherein the illumination unit comprises an electronic device for identifying the illumination apparatus.

21. The apparatus of claim 20 wherein the electronic device comprises data representative of the spectral characteristics and calibration data of the illumination apparatus.

22. The apparatus of claim 16 wherein the illumination is switched on and off synchronously with image capture process in the image sensing device.

23. The apparatus of claim 16 further comprising means for storing a plurality of images, each image providing a representation of part of the object at different positions over the object surface; and
a processor for analysing the plurality of images and generating a larger image on the basis of the images indicative of the overall object.

24. The apparatus of claim 16 further comprising at least one position sensor for indicating the position of the apparatus with respect to the object.

25. The apparatus according to claim 16, further comprising an indicator to indicate to a user when the image of the object to be inspected is out of focus.

26. The apparatus of claim 16 wherein the image sensing device is a CCD digital camera.

27. A system for inspecting an object in a non-contact manner, the system comprising a handheld inspection apparatus according to claim 16 and a computing means arranged to receive actual image data representative of the one or more images captured by the handheld inspection apparatus and comparing the actual image data with predetermined image data.

28. The system of claim 27 further comprising a mechanical movable means wherein the handheld inspection apparatus is mounted on the movable means such that movement is the handheld inspection apparatus is based on movement of the movable means.

29. The system of claim 28 wherein the mechanically movable means is a robot arm.

30. A method of producing a dimensionally representative image of an object, the method comprising the steps of
holding a camera unit including a telecentric lens with respect to the object such that a gap exists between the camera and the object;
sequentially energising a plurality of light sources;
capturing a plurality of images in response to the sequential energisation; and comparing the plurality of images to determine surface irregularity of the object.

31. The method according to claim 30 further comprising the step of capturing a series of images of the object by moving the camera unit over the object and comparing the images in order to generate an overall image of the object.
